(19) United States
(12) Patent Application Publication
(10) Pub. No.: US 2025/0002357 A1
(43) Pub. Date: Jan. 2, 2025

(54) TANDEM CIRCULATORY SYSTEM TO REDUCE THE RISK OF CARBON DIOXIDE LEAKAGE DURING CARBON DIOXIDE SEQUESTRATION IN SALINE DEEP-WATER AQUIFERS

(71) Applicant: SAUDI ARABIAN OIL COMPANY, Dhahran (SA)

(72) Inventors: Bander Al Quaimi, AlKhboar (SA); Hassan Al Hashim, Dammam (SA)

(73) Assignee: SAUDI ARABIAN OIL COMPANY, Dhahran (SA)

(21) Appl. No.: 18/342,116

(22) Filed: Jun. 27, 2023

(51) Int. Cl. C01B 32/50

(52) U.S. Cl. CPC C01B 32/50

(57) ABSTRACT

A system for reducing carbon dioxide leakage during carbon dioxide sequestration in saline deep-water aquifers including one or more carbon dioxide injectors submerged into an aquifer with a plurality of pressure sensors on the injectors, one or more saline water producing wells submerged into an aquifer, a process line to transfer the saline water from the producing wells to an adjacent wetland, and a local pressure monitoring interface.

### BACKGROUND

Carbon dioxide (CO₂) is a naturally occurring compound that is present in Earth's atmosphere. The CO₂ in the atmosphere may be derived from natural sources, such as respiration, or from human activities, including the combustion of fossil fuels. The environmental effects of CO₂ in the atmosphere are of particular concern because CO₂ is a “greenhouse gas”. A greenhouse gas can absorb light and radiate heat instead of reflecting it, elevating the temperature of the gas. In an effort to slow the rate of global warming, carbon capture and storage (CCS) has emerged as a possible solution for reducing CO₂ in the atmosphere. In a typical CCS process, atmospheric CO₂ is captured, compressed, and transported with the eventual goal of long-term storage in underground geological formations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for reducing carbon dioxide leakage during carbon dioxide sequestration in saline deep-water aquifers. The system includes one or more carbon dioxide injectors and one or more saline water producing wells, both with an end submerged in the aquifer. The carbon dioxide injectors include pressure sensors in the submerged end and a local pressure monitoring interface. The system includes a process line to transfer the saline water from the saline producing wells to an adjacent wetland.

In another aspect, embodiments disclosed herein relate to a method for reducing carbon dioxide leakage during carbon dioxide sequestration in saline deep-water aquifers. The method includes injecting a volume of carbon dioxide for storage into the saline deep-water aquifer using one or more carbon dioxide injectors. The pore pressure and the ground pressure are monitored with pressure sensors. One or more saline water producing wells activate based on the pore pressure exceeding a set point or a fracture pressure. When the producing wells activate, the saline water is pumped from the saline deep-water aquifer to an adjacent wetland to reduce the pore pressure of the aquifer, improve the aquifer storage capacity, and prevent fractures.

Other aspects and advantages of the claimed subject matter will be apparent from the following description and the appended claims.

### BRIEF DESCRIPTION OF DRAWINGS

FIG. 1 is a process flow diagram according to one or more embodiments.

FIG. 2 is a physical representation of the system according to one or more embodiments.

### DETAILED DESCRIPTION

Embodiments disclosed herein relate to a method and a system for storing carbon dioxide in a saline deep-water aquifer using carbon dioxide injectors and saline water producing wells to inject carbon dioxide and displace saline water to a nearby wetland, allowing storage without aquifer damage due to over-pressurization.

During injection, the carbon dioxide is typically in a supercritical state to facilitate the transport, injection, and storage in geological formations. To achieve the supercritical state for injection, the carbon dioxide is compressed and heated prior to injection. In this supercritical state, carbon dioxide has properties of both a liquid and gas, which facilitates its transport, injection, and storage in geological formations. The specific temperature and pressure conditions of the carbon dioxide during injection may vary depending on the storage site and operational requirements, though these parameters typically exceed that of the critical point. For example, the depth of the storage formation and the target injection rate may require carbon dioxide to be injected at a higher temperature and pressure than the critical point, due to the increase in temperature and pressure at deeper depths under the surface of the earth.

Carbon dioxide sequestration is the process of capturing, removing, and storing carbon dioxide from the atmosphere of the earth. Carbon dioxide can be injected into a saline deep-water aquifer, which has a specific capacity intrinsic to it. Exceeding this capacity can cause problematic phenomena, including fractures, which may lead to carbon dioxide leakage through the cap rock. A saline deep-water aquifer contains several layers including an upper layer of cap rock and a lower layer called the deep saline traps. The carbon dioxide is injected just beneath the cap rock in the deep saline trap forming a pocket, with carbon dioxide dispersing throughout the cap rock. This increased pressure could result in failure of aquifer or the cap rock.

The injection of carbon dioxide increases pore pressure as the space of the aquifer fills up and pushes into the cap rock. As the pore pressure of the rock increases, the remaining storage capacity declines. Accordingly, there exists a need for a system to monitor and reduce the pore pressure as needed in the aquifer to allow for additional storage of carbon dioxide without incidental fractures or other aquifer damage.

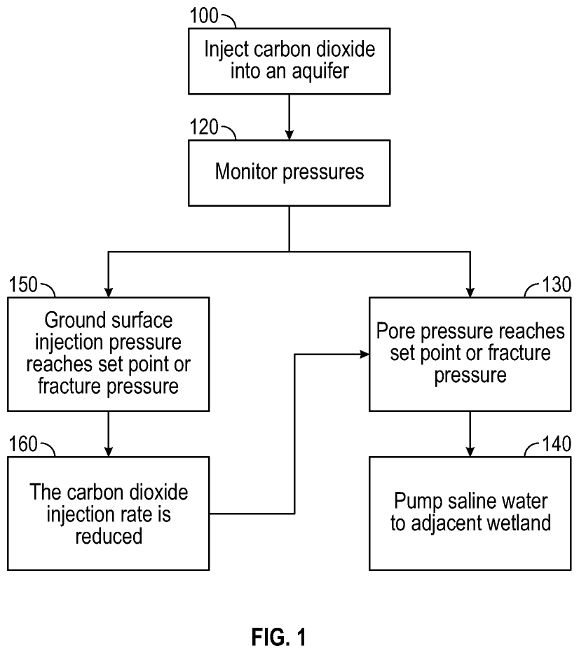

Referring now to FIG. 1, a process flow diagram of a process for injecting CO2 into a saline aquifer is illustrated. In FIG. 1, the process begins with the injection of carbon dioxide into a saline deep-water aquifer 100. Injectors are used for injecting carbon dioxide. In one embodiment, there may be a single carbon dioxide injector. In other embodiments, there may be multiple carbon dioxide injectors. When there are multiple carbon dioxide injectors, the carbon dioxide injectors should be located near each other. These injectors inject carbon dioxide below the cap rock layer into the deep saline trap of the aquifer. The carbon dioxide forms a gaseous pocket above the saline fluid by displacing the saline water deeper in the aquifer, thus increasing the pore pressure of the system.

Pressure is monitored 120 throughout injection 100 using pressure sensors. A portion of the pressure sensors may be placed in the carbon dioxide injector near the ground surface to monitor the ground surface injection pressure and identify whether this pressure reaches a set point or fracture pressure 150. This ground surface injection pressure is the pressure of the carbon dioxide as it is injected. These pressure sensors may be installed near the wellhead or at the injection manifold. The remaining pressure sensors are located at different depths within the reservoir to monitor the pore pressure and identify whether this pressure reaches a setpoint or fracture pressure 130. The pore pressure is the pressure of carbon dioxide as it disperses underground following injection, specifically within the rock. These sensors are installed during well construction and are separated by isolation kits or mechanical packers at the injection interval. Mechanical packers are placed above and below the injection location with pressure and temperature sensors to monitor the injection zone. Shiftable blank pipes (for example, sliding sleeves) with mechanical packers are also utilized in other intersected zones to isolate the zones and monitor pressures if required. Sensors may be powered with batteries, a power cord, or combinations thereof. The sensor readings are monitored using a local pressure monitoring interface located at the ground surface. This local pressure monitoring interface may display pore pressure, ground surface injection pressure, and other system parameters necessary to monitor and facilitate pore pressure reduction.

If the ground surface injection pressure reading approaches a setpoint or a fracture pressure 150, the carbon dioxide injection rate may be reduced manually or through automation 160. The setpoint and fracture pressures depend on the aquifer depth. The pore pressure readings from the downhole sensors indicate whether there is a need for pressure reduction, as pore pressures approach a fracture pressure or a setpoint 130. Pressure readings of both ground surface injection pressure and pore pressure approaching the fracture pressure or a setpoint could lead to fractures if additional carbon dioxide is injected without any pressure reduction mechanism. Once the pore pressure reading approaches these values, saline water is pumped to an adjacent wetland through saline water producing wells 140. This system adjustment may be manually directed by opening a valve and turning on a pump for the saline water producing well, or it may be automated. In some embodiments, both the ground surface injection pressure and pore pressure will trigger pressure reduction efforts. In other embodiments, only one of these two pressures may reach a setpoint or fracture pressure requiring pressure reduction efforts at a given time. In some embodiments, there may be a single saline water producing well. In other embodiments, there may be multiple saline water producing wells. The flow rate of the saline water producing wells may be in a range of 500 and 2000 barrels per day per well, depending on the volume of carbon dioxide injected by the injection well. When there are multiple saline water producing wells, the saline water producing wells should be located near each other. Removing saline water reduces the pressure in the deep saline traps, subsequently reducing the pore pressure, and thus lowering the risk of fractures.

The pressure readings from both types of pressure sensors are monitored for several purposes. Monitoring the ground surface injection pressure sensors allows process safety control during injection, preventing any fractures from forming due to excessive injection pressure while simultaneously maximizing injection rate of carbon dioxide. The data from monitoring the pressure also allows optimization of the carbon dioxide injection rate to maximize the carbon storage while minimizing any potential environmental and financial risks associated with inducing fractures during sequestration. Understanding pressure changes can assist in injection optimization by providing insight into the carbon dioxide plume movement and behavior, allowing injection strategies and additional monitoring or intervention activities, such as production well drilling.

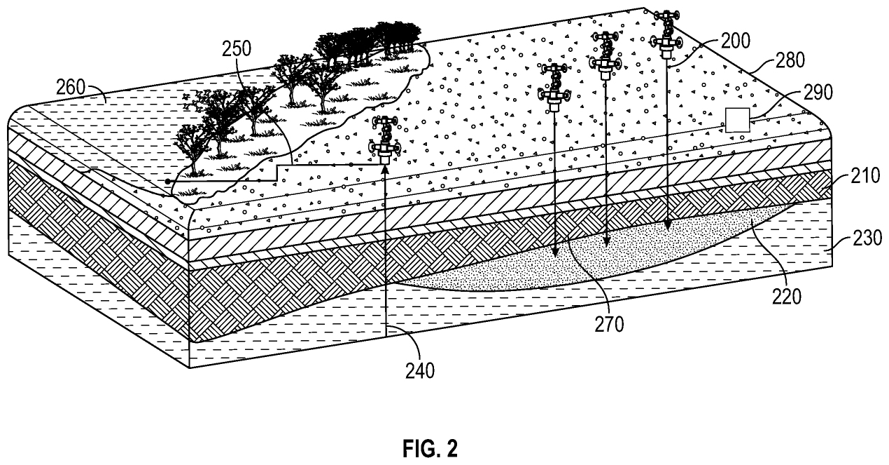

FIG. 2 illustrates an example of the system configuration, which can be used to help understand the process flow described above. The one or more carbon dioxide injectors 200 vertically penetrate through the cap rock 210 with one end submerged into the saline deep-water layer 230 within the aquifer. The carbon dioxide injectors contain multiple pressure sensors proximate the submerged ends 270 and at the ground surface 280. A local pressure monitoring interface 290 is located near the carbon dioxide injectors. Injection of carbon dioxide forms a pocket of carbon dioxide storage 220 above the deep saline trap and below the cap rock. One or more saline water producing wells 240 vertically penetrate through the caprock 210 with one end submerged into the saline deep-water layer. The saline water producing wells are located a horizontal distance away from the carbon dioxide injectors, ranging from 3 meters to 3 kilometers. By ensuring horizontal distance between the carbon dioxide injectors and saline water producing wells, carbon dioxide leakage into the saline water producing well stream is prevented. Other factors impact the horizontal distance between the saline water producing well and the carbon dioxide injectors, including specific reservoir characteristics, such as the porosity and permeability. The saline water producing well inlet is located vertically deeper into the aquifer than the carbon dioxide injector outlet, but still within the same vertical hydraulic layer, to prevent carbon dioxide leakage into the saline water producing well stream. A process line 250 transfers a flow of saline water from the saline water producing wells 240 to an adjacent wetland, such as an artificial or a constructed lake 260. The nearby wetland may contain any vegetation that lives in saline environments and provides a solution for reuse of the produced saline water.

Embodiments of the present disclosure may provide at least one of the following advantages. Using this method and system, carbon dioxide will be injected and stored in aquifers without the risk of fracture damage to the formation and carbon dioxide leakage. Preventing carbon dioxide leakage helps optimize carbon dioxide storage, a primary goal of carbon dioxide sequestration. The amount of carbon dioxide able to be successfully stored will be maximized for each aquifer by removing saline water to provide additional storage capacity. The saline water being pumped through saline water producing wells will be reused for adjacent wetlands and vegetation.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for reducing carbon dioxide leakage during carbon dioxide sequestration in saline deep-water aquifers, comprising:
one or more carbon dioxide injectors penetrating through a layer of rock with an end submerged into a saline deep-water layer within an aquifer and an opposite end above a ground surface;
one or more saline water producing wells penetrating through the layer of rock with one end submerged into the saline deep-water layer within an aquifer;
a process line to transfer a flow of saline water from the saline water producing wells to an adjacent wetland;
a plurality of pressure sensors installed in the one or more carbon dioxide injectors proximate the submerged ends and at the ground surface; and
a local pressure monitoring interface.

2. The system of claim 1, wherein the one or more carbon dioxide injectors are at between 3 m and 1.5 km away from the saline water producing wells.

3. The system of claim 1, wherein the plurality of pressure sensors are in communication with the local pressure monitoring interface.

4. The system of claim 1, further comprising a power source for supplying an electrical power to the plurality of pressure sensors, wherein the power source is hardwired, battery powered, or both.

5. The system of claim 1, wherein the adjacent wetland is an artificial lake.

6. A method for reducing carbon dioxide leakage during carbon dioxide sequestration in saline deep-water aquifers, comprising:
injecting a volume of carbon dioxide for storage into the saline deep-water aquifer using one or more carbon dioxide injectors;
monitoring a pore pressure and a ground surface pressure with a plurality of pressure sensors installed in a submerged end and at a ground surface of the one or more carbon dioxide injectors;
activating one or more saline water producing wells when the pore pressure exceeds a set point or a fracture pressure for the saline deep-water aquifer;
pumping saline water from the saline deep-water aquifer to an adjacent wetland upon activation of the one or more saline water producing wells to reduce the pore pressure of the saline deep-water aquifer, improve an aquifer storage capacity, and prevent fractures.

7. The method of claim 6, wherein the volume of carbon dioxide injected varies based on depth of the aquifer.

8. The method of claim 6, wherein the set point for activating the saline water producing wells varies based on the depth of the aquifer.

9. The method of claim 6, wherein the pore pressure is communicated on a local pressure monitoring interface above a ground surface.

10. The method of claim 6, wherein the saline water is pumped at a flowrate between 500 and 2000 barrels per day per well.

11. The method of claim 6, wherein the adjacent wetland is an artificial lake.
